(19) United States
(12) Patent Application Publication
(10) Pub. No.: US 2024/0330737 A1
(43) Pub. Date: Oct. 3, 2024

(54) SYSTEMS AND METHODS FOR LOW-COST SIMULATION OF QUANTUM ALGORITHMS

(71) Applicant: JPMORGAN CHASE BANK, N.A., New York, NY (US)

(72) Inventors: Ruslan SHAYDULIN, New York, NY (US); Yue SUN, Short Hills, NJ (US); Marco PISTOIA, Amawalk, NY (US)

(21) Appl. No.: 18/192,562

(22) Filed: Mar. 29, 2023

(51) Int. Cl. G06N 10/80

(52) U.S. Cl. CPC G06N 10/80

(57) ABSTRACT

Systems and methods for low-cost simulation of quantum algorithms are disclosed. A method may include a quantum computer simulator computer program: (1) receiving a compact description of a problem and an objective to evaluate, a first circuit parameter, and a second circuit parameter; (2) precomputing a diagonal vector comprising diagonal elements of a phase Hamiltonian; (3) initializing a state vector; (4) applying a phase operator to the state vector with the first circuit parameter; (5) applying a mixing operator to the state vector with the second circuit parameter; (6) reading the state vector; (7) computing a quality of the state vector based on the objective; and (8) updating the first circuit parameter and the second circuit parameter based on the quality.

### BACKGROUND OF THE INVENTION

### 1. Field of the Invention

Embodiments relate generally to systems and methods for low-cost simulation of quantum algorithms.

### 2. Description of the Related Art

Solving optimization algorithms, like portfolio optimization, is a promising use case of quantum computers. The goal of optimization is to find a binary string minimizing some objective function ƒ. Quantum computer simulators executed by classical computers are often used to analyze and debug quantum algorithms before they are run on actual quantum computers. These simulators, however, are too slow to be used in practice for large systems.

### SUMMARY OF THE INVENTION

Systems and methods for low-cost simulation of quantum algorithms are disclosed. According to an embodiment, a method for low-cost simulation of quantum algorithms may include: (1) receiving, at a quantum computer simulator computer program executed by a classical computer and from a client application, a compact description of a problem and an objective to evaluate, a first circuit parameter, and a second circuit parameter; (2) precomputing, by the quantum computer simulator computer program, a diagonal vector comprising diagonal elements of a phase Hamiltonian; (3) initializing, by the quantum computer simulator computer program, a state vector; (4) applying, by the quantum computer simulator computer program, a phase operator to the state vector with the first circuit parameter; (5) applying, by the quantum computer simulator computer program, a mixing operator to the state vector with the second circuit parameter; (6) reading, by the quantum computer simulator computer program, the state vector; (7) computing, by the quantum computer simulator computer program, a quality of the state vector based on the objective; and (8) updating, by the quantum computer simulator computer program, the first circuit parameter and the second circuit parameter based on the quality.

In one embodiment, the compact description of the problem comprises a computer program that computes a cost function to be optimized.

In one embodiment, the objective to evaluate comprises an expectation value that is an inner product between the phase operator and the state vector.

In one embodiment, the objective to evaluate comprises an expectation value that is a sum of selected square absolute values of state vector entries.

In one embodiment, the method may also include receiving, by the quantum computer simulator computer program, an initial vector, wherein the initial vector comprises a vector having a length of 2ⁿ and elements equal to

$$\frac{1}{{2}^{\frac{n}{2}}} ,$$

wherein n is a number of qubits in the state vector.

In one embodiment, the first circuit parameter corresponds to a time for which evolution is performed in the phase operator, and the second circuit parameter corresponds to a time for which evolution is performed in the mixing operator.

In one embodiment, the step of applying, by the quantum computer simulator computer program, the phase operator to the state vector with the first circuit parameter comprises: multiplying a cost vector by −iγⱼ and then exponentiating element-by-element, resulting in a phase vector; and calculating an element-by-element product between the state vector and the phase vector.

In one embodiment, the step of applying the mixing operator to the state vector with the second circuit parameter comprises: performing, by the quantum computer simulator computer program, a Fast Uniform SU(2) Transform on the state vector; and applying, by the quantum computer simulator computer program, the phase operator to the state vector.

In one embodiment, the method may also include: repeating, by the quantum computer simulator computer program, the steps of applying the phase operator to the state vector with the updated first circuit parameter, applying the mixing operator to the state vector with the updated second circuit parameter, reading the state vector, and computing the quality of the state vector based on the objective until a stopping criteria is met.

In one embodiment, the stopping criteria comprises the quality between iterations changing by less than a certain amount.

According to another embodiment, a non-transitory computer readable storage medium, may include instructions stored thereon, which when read and executed by one or more computer processors, cause the one or more computer processors to perform steps comprising: receiving, from a client application, a compact description of a problem and an objective to evaluate, a first circuit parameter, and a second circuit parameter; precomputing a diagonal vector comprising diagonal elements of a phase Hamiltonian; initializing a state vector; applying a phase operator to the state vector with the first circuit parameter; applying a mixing operator to the state vector with the second circuit parameter; reading the state vector; computing a quality of the state vector based on the objective; and updating the first circuit parameter and the second circuit parameter based on the quality.

In one embodiment, the compact description of the problem comprises a computer program that computes a cost function to be optimized.

In one embodiment, the objective to evaluate comprises an expectation value that is an inner product between the phase operator and the state vector.

In one embodiment, the objective to evaluate comprises an expectation value that is a sum of selected square absolute values of state vector entries.

In one embodiment, the non-transitory computer readable storage medium may also include instructions stored thereon, which when read and executed by one or more computer processors, cause the one or more computer processors to perform steps comprising: receiving an initial vector, wherein the initial vector comprises a vector having a length of 2ⁿ and elements equal to

$$\frac{1}{{2}^{\frac{n}{2}}} ,$$

wherein n is a number of qubits in the state vector.

In one embodiment, the first circuit parameter corresponds to a time for which evolution is performed in the phase operator, and the second circuit parameter corresponds to a time for which evolution is performed in the mixing operator.

In one embodiment, the phase operator is applied to the state vector with the first circuit parameter by: multiplying a cost vector by −iγⱼ and then exponentiating element-by-element, resulting in a phase vector; and calculating an element-by-element product between the state vector and the phase vector.

In one embodiment, the mixing operator is applied to the state vector with the second circuit parameter by: performing a Fast Uniform SU(2) Transform on the state vector; and applying the phase operator to the state vector.

In one embodiment, the non-transitory computer readable storage medium may also include instructions stored thereon, which when read and executed by one or more computer processors, cause the one or more computer processors to perform steps comprising: repeating the application of the phase operator to the state vector with the updated first circuit parameter, the application of the mixing operator to the state vector with the updated second circuit parameter, the reading of the state vector, and the computation of the quality of the state vector based on the objective until a stopping criteria is met.

In one embodiment, the stopping criteria comprises the quality between iterations changing by less than a certain amount.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts an architectural diagram for low-cost simulation of quantum algorithms according to an embodiment;

FIG. 2 depicts a method for low-cost simulation of quantum algorithms according to an embodiment.

FIG. 3 depicts an exemplary computing system for implementing aspects of the present disclosure.

### DETAILED DESCRIPTION OF PREFERRED EMBODIMENTS

Embodiments relate generally to systems and methods for low computing cost simulation of quantum algorithms. For example, embodiments may reduce the number of cycles and/or processing time for the simulation.

Embodiments may use a computer program executed by a classical computer to simulate the execution of a quantum algorithm, such as the Quantum Approximate Optimization Algorithm (QAOA) on a quantum computer. For example, embodiments may propagate a 2ⁿ-dimensional vector describing the quantum state of n qubits (i.e., the “state vector”). Embodiments may leverage the observation that diagonal operations, such as those in the QAOA, are easier to simulate than non-diagonal operations.

Embodiments may include the fast simulation of the phase operator U_{C}(γⱼ)=e^{-iγ}^{ⱼ}^{C} in the QAOA by precomputing and storing a phase Hamiltonian C for an optimization problem x. For example, before the simulation is started, a 2ⁿ-dimensional vector containing the diagonal elements of phase Hamiltonian C, including cost vector diag(C)=ƒ(x), may be precomputed by evaluating the objective function to be optimized on all possible 2ⁿ binary strings, where n is the number of binary variables in the optimization problem.

Diagonal elements may be elements on the main diagonal of a square matrix. A diagonal operator may be a square matrix which only has non-zero elements on its main diagonal, and all elements off of the main diagonal are zero.

During the simulation, the phase operator U_{C}(γⱼ) may be applied by multiplying the state vector, element-by-element, by phase vector e^{-iγ}^{ⱼ}^{diag (C)}.

Embodiments may also provide fast simulation of the mixing operator U_{B}(βⱼ)=e^{-iβ}^{ⱼ}^{B} in QAOA in three steps, where a mixing Hamiltonian, B=ΣₖXₖ, and Xₖ the Pauli-X operator are applied on qubit k. For example, embodiments may perform a Fast Uniform SU(2) Transform on the state vector as specified below with aᵢ=cos βⱼ and bᵢ=sin βⱼ for all i.

For example, the Fast Uniform SU(2) transform may apply single qubit unitary operations Uᵢ∈SU(2) on every 2-dimensional subspace (i.e., a qubit) of the quantum system represented by a state vector.

For example, the inputs to the Fast Uniform SU(2) transform may include vector x∈ [symbol] ^{N}, a unitary matrix U∈SU(N) that is decomposable into a tensor product of n unitary matrices in SU(2) such that U=⊗ᵢ₌₁ⁿ Uᵢ=Uₙ⊗ . . . ⊗U₂⊗U₁, where

$${U}_{i} = ( \begin{matrix}{a}_{i} & - {b}_{i}^{*} \\ {b}_{i} & {a}_{i}^{*}\end{matrix} )$$

∈SU(2) and N=2ⁿ. The output may be a vector y=Ux. First, the output vector is initialized y←x and several nested loops are run to compute indices l₁ and l₂:

```
for i = 1 to n do
  for j = 1 to 2ⁿ⁻ⁱ do
    for k = 1 to 2ⁱ⁻¹ do
      Compute indices:
        l₁ ← (j − 1)2ⁱ + k
        l₂ ← (j − 1)2ⁱ + k + 2ⁱ⁻¹
      Simultaneously update yₗ_{₁} and yₗ_{₂}:
        yₗ_{₁} ← aᵢyₗ_{₁} − bᵢ*yₗ_{₂}
        yₗ_{₂} ← bᵢyₗ_{₁} + aᵢ*yₗ_{₂}
    end for
  end for
end for
return y
```

At the end of the processing, the output vector (i.e., the state vector that then has a unitary operator applied) is returned.

In another embodiment, a different implementation of the fast uniform SU(2) transform may be used. Additional inputs a, b∈ [symbol] ^{N} define the unitary matrix U as specified above. First, the output vector is initialized y←x, and an uninitialized temporary swap buffer s∈ [symbol] ^{N}. Then, several nested loops are run to compute the output vector:

```
for i = 1 to n do
  for j = 1 to 2ⁿ⁻¹ do
    Update output vector:
      sⱼ ← aᵢyⱼ − bᵢ*yⱼ₊₁
      sⱼ₊₂_{^{n−1}} ← bᵢyⱼ + aᵢ*yⱼ₊₁
  end for
  Swap y and s
end for
if n mod 2 = 1 then
  Swap y and s
end if
return y
```

In embodiments, an inner product may be taken between diag(C) and the probabilities vector (computable from taking the element-by-element squared norm of the state vector) to obtain the expected solution quality of the quantum algorithm.

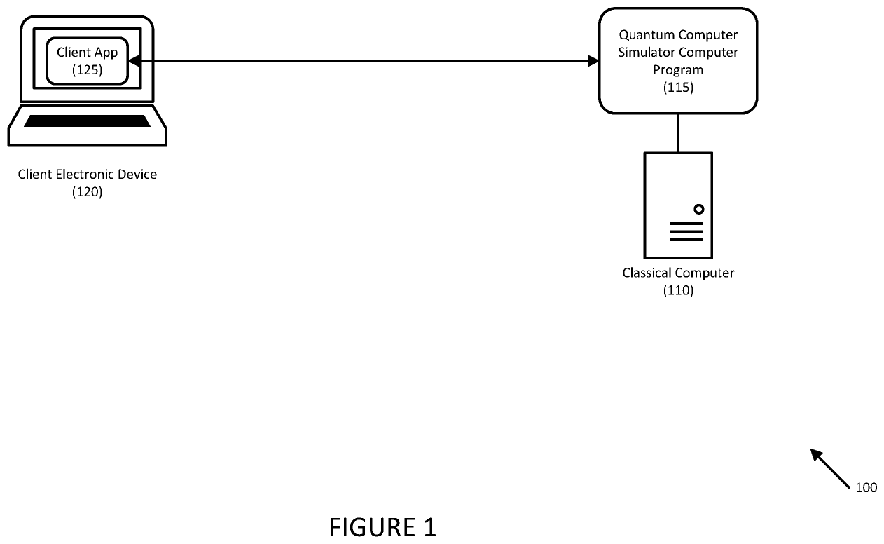

Referring to FIG. 1, a system for low-cost simulation of quantum algorithms is disclosed according to an embodiment. System 100 may include classical computer 110, which may be a server (e.g., physical and/or cloud-based), a computer (e.g., workstation, desktop, laptop, etc.), etc. that may execute quantum computer simulator computer program 115. Quantum computer simulator computer program 115 may simulate the operation of a quantum computer.

In one embodiment, classical computer 110 may include a central processing unit (CPU) and a graphical processing unit (GPU). The simulation may be executed on both the CPU and GPU as is necessary and/or desired.

System 100 may further include client electronic device 120, which may execute client computer program or application (“app”) 125. Client app 125 may interface with quantum computer simulator computer program 115 and may provide instructions for quantum computer simulator computer program 115 to execute.

In one embodiment, client app 125 may provide a compact description of the optimization problem to be solved (such as a code computing the cost function that the user wants to optimize) and circuit parameters β, γ for the algorithm to simulate.

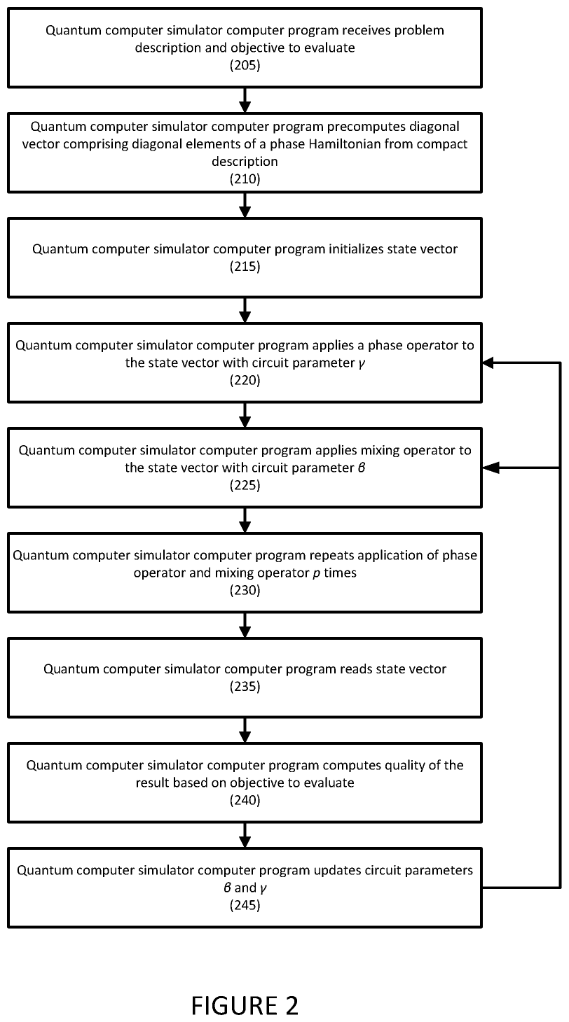

Referring to FIG. 2, a method for low-cost simulation of quantum algorithms is disclosed according to an embodiment.

In step 205, a computer program, such as a quantum computer simulator computer program, may receive a compact description of a problem and an objective to evaluate from, for example, a client application. For example, the quantum computer simulator computer program may receive a computer program that computes a cost function ƒ to be optimized, circuit parameters β and γ.

In one embodiment, circuit parameters β and γ may be numbers that are specified by the user. The circuit parameters may correspond to the time for which the evolution is performed in the corresponding phase operator U_{C}(γⱼ)=e^{-iγ}^{ⱼ}^{C} or mixing operator U_{B}(βⱼ)=e^{-iβ}^{ⱼ}^{B}.

The cost function, x, may also be a user choice. An example of a user choice for a cost function is a cut in a graph. An example is disclosed in Ausiello, Giorgio et al., “Complexity and Approximation: Combinatorial Optimization Problems and Their Approximability Properties” (2003), the disclosure of which is hereby incorporated, by reference, in its entirety.

In embodiments, an initial vector may optionally be provided. The initial vector may be a standard fiduciary vector that may be used with a variety of different problems. For example, it may be desirable to provide an input vector if “warm-starting” the quantum algorithm. Specifically, one may desire to start the quantum optimization from an output of some classical solver (i.e., “warm-start”). In that case, the input vector may be modified to reflect the knowledge obtained from classical solver.

The objective to evaluate may be, for example, an expectation value (e.g., an inner product between the phase Hamiltonian C and the state vector) or a success probability (e.g., a sum of square absolute values of state vector entries). For example, all entries of the state vector may be squared. The objective may measure the quality of the simulation of the problem.

In step 210, the quantum computer simulator computer program may precompute a diagonal vector that may be a 2ⁿ-dimensional vector including the diagonal elements of a phase Hamiltonian C, including cost vector diag(C)=ƒ(x). The compact description may evaluate the cost function to be optimized on all possible 2ⁿ binary strings, where n is the number of binary variables in the optimization problem. The binary strings are the input to the objective function.

In step 215, the quantum computer simulator computer program may initialize a state vector, from which the output vector may be constructed. For example, the initial vector may be a vector having a length of 2ⁿ and all elements being

$$\frac{1}{{2}^{\frac{n}{2}}} .$$

In step 220, the quantum computer simulator computer program may apply the phase operator, U_{C}(γⱼ)=e^{-iγ}^{ⱼ}^{C}, to the state vector with the circuit parameter γ. In one embodiment, this may be done by taking an element wise product between the state vector and the phase vector e^{-iγ}^{ⱼ}^{diag(C)}. The phase vector e^{-iγ}^{ⱼ}^{diag}(C) may be obtained by multiplying the cost vector diag(C) by −iγⱼ and then exponentiating element-by-element.

In step 225, the quantum computer simulator computer program may apply a mixing operator, U_{B}(βⱼ)=e^{-iβ}^{ⱼ}^{B}, to the state vector with the circuit parameter β. For example, embodiments may perform a Fast Uniform SU(2) Transform on the state vector as specified above with aᵢ=cos βⱼ and bᵢ=sin βⱼ for all i.

In step 230, the quantum computer simulator computer program may repeat the application of the phase operator and the mixing operator p times. The value p may be specified by the user. For example, higher values of p may lead to higher quality in the output vector, but will take more cycles to achieve.

In step 235, the quantum computer simulator computer program may read the state vector. In one embodiment, the computer program may read and return the state vector as an object, for example, by providing a copy of it.

In step 240, the quantum computer simulator computer program may compute a quality of the state vector based on the objective to evaluate. For example, an inner product may be taken between the phase Hamiltonian C and the state vector to obtain the expected solution quality of the quantum algorithm. The solution quality may be a number.

In step 245, the computer program may update the circuit parameters β and γ and may return to steps 220 and 235. For example, circuit parameters β and γ may be updated with, for example, an optimization routine to optimize the circuit parameters. Any suitable mechanism for updating the circuit parameters β and γ may be used as is necessary and/or desired. For example, techniques such as gradient descent, Nelder-Mead, etc. may be used as is necessary and/or desired.

In one embodiment, the process may continue until the quality reaches a certain value, the user decides to stop, etc. For example, the computer program may continue updating and sending circuit parameters β and γ until some stopping criteria is satisfied, such as when the quality of the state vector stops improving by more than a certain amount. In one embodiment, once the quality changes by less than a certain amount, percentage, etc. the process may stop. An example of the termination criterion for Nelder-Mead is disclosed in Nash, J. C. “Compact Numerical Methods: Linear Algebra and Function Minimisation” (1979), the disclosure of which is hereby incorporated, by reference, in its entirety.

In another embodiment, the stopping criteria may be specified by the user.

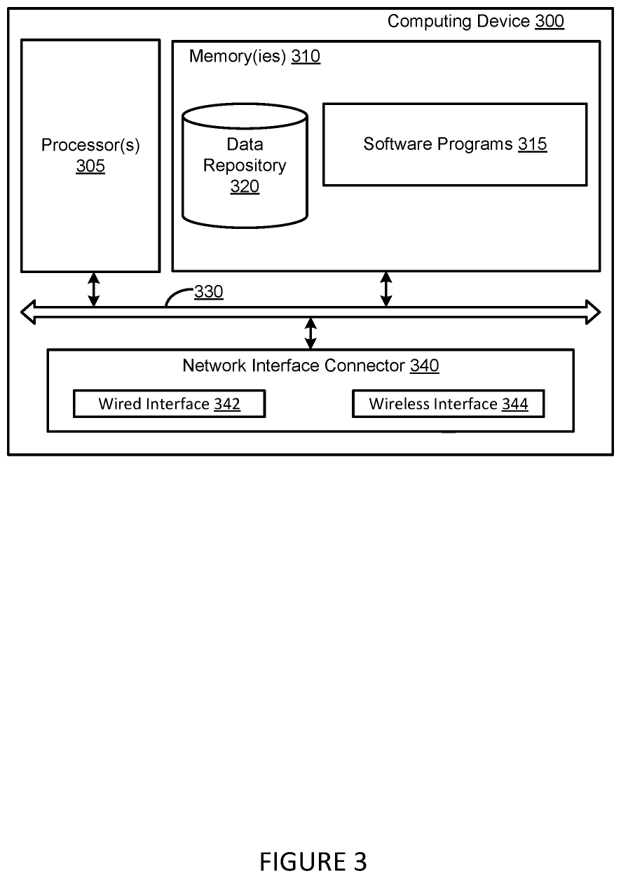

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Additional details are provided in the attached Appendix, the disclosure of which is hereby incorporated, by reference, in its entirety.

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for low-cost simulation of quantum algorithms, comprising:
receiving, at a quantum computer simulator computer program executed by a classical computer and from a client application, a compact description of a problem and an objective to evaluate, a first circuit parameter, and a second circuit parameter;
precomputing, by the quantum computer simulator computer program, a diagonal vector comprising diagonal elements of a phase Hamiltonian;
initializing, by the quantum computer simulator computer program, a state vector;
applying, by the quantum computer simulator computer program, a phase operator to the state vector with the first circuit parameter;
applying, by the quantum computer simulator computer program, a mixing operator to the state vector with the second circuit parameter;
reading, by the quantum computer simulator computer program, the state vector;
computing, by the quantum computer simulator computer program, a quality of the state vector based on the objective; and
updating, by the quantum computer simulator computer program, the first circuit parameter and the second circuit parameter based on the quality.

2. The method of claim 1, wherein the compact description of the problem comprises a computer program that computes a cost function to be optimized.

3. The method of claim 1, wherein the objective to evaluate comprises an expectation value that is an inner product between the phase operator and the state vector.

4. The method of claim 1, wherein the objective to evaluate comprises an expectation value that is a sum of selected square absolute values of state vector entries.

5. The method of claim 1, further comprising:
receiving, by the quantum computer simulator computer program, an initial vector, wherein the initial vector comprises a vector having a length of 2ⁿ and elements equal to
$$\frac{1}{{2}^{\frac{n}{2}}} ,$$
wherein n is a number of qubits in the state vector.

6. The method of claim 1, wherein the first circuit parameter corresponds to a time for which evolution is performed in the phase operator, and the second circuit parameter corresponds to a time for which evolution is performed in the mixing operator.

7. The method of claim 1, wherein the step of applying, by the quantum computer simulator computer program, the phase operator to the state vector with the first circuit parameter comprises:
multiplying a cost vector by −iγⱼ and then exponentiating element-by-element, resulting in a phase vector; and
calculating an element-by-element product between the state vector and the phase vector.

8. The method of claim 1, wherein the step of applying the mixing operator to the state vector with the second circuit parameter comprises:
performing, by the quantum computer simulator computer program, a Fast Uniform SU(2) Transform on the state vector; and
applying, by the quantum computer simulator computer program, the phase operator to the state vector.

9. The method of claim 1, further comprising:
repeating, by the quantum computer simulator computer program, the steps of applying the phase operator to the state vector with the updated first circuit parameter, applying the mixing operator to the state vector with the updated second circuit parameter, reading the state vector, and computing the quality of the state vector based on the objective until a stopping criteria is met.

10. The method of claim 9, wherein the stopping criteria comprises the quality between iterations changing by less than a certain amount.

11. A non-transitory computer readable storage medium, including instructions stored thereon, which when read and executed by one or more computer processors, cause the one or more computer processors to perform steps comprising:
receiving, from a client application, a compact description of a problem and an objective to evaluate, a first circuit parameter, and a second circuit parameter;
precomputing a diagonal vector comprising diagonal elements of a phase Hamiltonian;
initializing a state vector;
applying a phase operator to the state vector with the first circuit parameter;
applying a mixing operator to the state vector with the second circuit parameter;
reading the state vector;
computing a quality of the state vector based on the objective; and
updating the first circuit parameter and the second circuit parameter based on the quality.

12. The non-transitory computer readable storage medium of claim 11, wherein the compact description of the problem comprises a computer program that computes a cost function to be optimized.

13. The non-transitory computer readable storage medium of claim 11, wherein the objective to evaluate comprises an expectation value that is an inner product between the phase operator and the state vector.

14. The non-transitory computer readable storage medium of claim 11, wherein the objective to evaluate comprises an expectation value that is a sum of selected square absolute values of state vector entries.

15. The non-transitory computer readable storage medium of claim 11, further including instructions stored thereon, which when read and executed by one or more computer processors, cause the one or more computer processors to perform steps comprising:
receiving an initial vector, wherein the initial vector comprises a vector having a length of 2ⁿ and elements equal to
$$\frac{1}{{2}^{\frac{n}{2}}} ,$$
wherein n is a number of qubits in the state vector.

16. The non-transitory computer readable storage medium of claim 11, wherein the first circuit parameter corresponds to a time for which evolution is performed in the phase operator, and the second circuit parameter corresponds to a time for which evolution is performed in the mixing operator.

17. The non-transitory computer readable storage medium of claim 11, wherein the phase operator is applied to the state vector with the first circuit parameter by:
multiplying a cost vector by −iγⱼ and then exponentiating element-by-element, resulting in a phase vector; and
calculating an element-by-element product between the state vector and the phase vector.

18. The non-transitory computer readable storage medium of claim 11, wherein the mixing operator is applied to the state vector with the second circuit parameter by:
performing a Fast Uniform SU(2) Transform on the state vector; and
applying the phase operator to the state vector.

19. The non-transitory computer readable storage medium of claim 11, further including instructions stored thereon, which when read and executed by one or more computer processors, cause the one or more computer processors to perform steps comprising:
repeating the application of the phase operator to the state vector with the updated first circuit parameter, the application of the mixing operator to the state vector with the updated second circuit parameter, the reading of the state vector, and the computation of the quality of the state vector based on the objective until a stopping criteria is met.

20. The non-transitory computer readable storage medium of claim of claim 19, wherein the stopping criteria comprises the quality between iterations changing by less than a certain amount.
